(19) United States
(12) Patent Application Publication
(10) Pub. No.: US 2016/0207446 A1
(43) Pub. Date: Jul. 21, 2016

(54) LIGHT FITTING STRUCTURE FOR A VEHICLE

(71) Applicant: TOYOTA JIDOSHA KABUSHIKI KAISHA, Toyota-shi (JP)

(72) Inventor: Tatsuya KUMEGAWA, Toyota-shi (JP)

(73) Assignee: TOYOTA JIDOSHA KABUSHIKI KAISHA, Toyota-shi (JP)

(21) Appl. No.: 14/973,316

(22) Filed: Dec. 17, 2015

(30) Foreign Application Priority Data
Jan. 16, 2015 (JP) 2015-006556

(51) Int. Cl. B60Q 1/26; B60Q 1/00; B60Q 1/30

(52) U.S. Cl. CPC B60Q 1/2653; B60Q 1/30; B60Q 1/2607; B60Q 1/0011

(57) ABSTRACT

A main body angled wall is formed at a vehicle width direction inner end portion of a main body outer lens. The main body angled wall is angled toward the vehicle width direction inner side and extends toward a vehicle front side in plan view. A main body projection that extends along the main body angled wall is included in a main body light guide and emission portion. Light that is emitted from a main body light source and enters the main body light guide and emission portion through a vehicle width direction outer end portion thereof is guided to the main body projection and reflected by plural prisms , and thus is emitted rearwardly from the vehicle.

### CROSS-REFERENCE TO RELATED APPLICATION

This application is based on and claims priority under 35 USC 119 from Japanese Patent Application No. 2015-006556 filed on Jan. 16, 2015, the disclosure of which is incorporated by reference herein in its entirety.

### BACKGROUND

1. Technical Field

The present disclosure relates to a light fitting structure for a vehicle.

2. Related Art

Japanese Utility Model Application Laid-Open (JP-U) No. H01-68224 discloses a door structure for a vehicle in which a gap between a combination lamp provided at a vehicle body rear face and a lamp provided at an end portion (rear face) of a back door (a vehicle trunk door or a rear hatch) is constant and a separation line thereof is substantially linear, as a result of which external appearance is improved.

Japanese Patent Application Laid-Open (JP-A) No. 2013-256140 discloses a technology relating to this door structure for a vehicle.

However, with the technology disclosed in JP-U No. H01-68224, when the lamp at the back door and the lamp at the vehicle main body are illuminated, when viewing the vehicle from behind, light-emitting regions of the two lamps may be discontinuous at the gap between the lamps. Thus, there is room for improvement with regard to improving visual design when the lamp at a vehicle back door and an adjacent lamp at a vehicle main body are illuminated and to improving visibility of a vehicle rear view (a view of the vehicle from behind).

### SUMMARY

In consideration of the circumstances described above, an object of the disclosed embodiments is to provide a light fitting structure for a vehicle at which, when a back door lamp and a main body lamp are illuminated, light-emitting regions of the two lamps are seen as being continuous when the vehicle is viewed from behind.

A light fitting structure for a vehicle according to a first aspect includes: a back door lamp provided at a vehicle width direction outer end portion of a back door provided at a rear end of a vehicle, a rear face of the back door lamp having a back door outer lens; a main body lamp provided at the rear end of the vehicle adjacent to a vehicle width direction outer end of the back door lamp, a rear face of the main body lamp having a main body outer lens; a back door light guide and emission portion provided in the back door lamp, the back door light guide and emission portion guiding and emitting light emitted from a back door light source; a main body light guide and emission portion provided in the main body lamp, a vehicle width direction inner end portion of the main body light guide and emission portion disposed so as to oppose a vehicle width direction outer end portion of the back door light guide and emission portion, the main body light guide and emission portion guiding and emitting light emitted from a main body light source; a main body angled wall formed at a vehicle width direction inner end portion of the main body outer lens of the main body lamp, the main body angled wall being angled inwardly in the vehicle width direction and extending toward the vehicle front side in a plan view seen from a vehicle upper side; and a main body projection formed at the main body light guide and emission portion, the main body projection extending along the main body angled wall from the vehicle width direction inner end portion of the main body light guide and emission portion.

In the light fitting structure according to the first aspect, the back door light guide and emission portion guides the light emitted from the back door light source of the back door lamp, and thus the back door light guide and emission portion emits light. Meanwhile, the main body light guide and emission portion guides the light emitted from the main body light source of the main body lamp, and thus the main body light guide and emission portion emits light.

The main body angled wall formed at the vehicle width direction inner end portion of the main body outer lens of the main body lamp is angled inwardly in the vehicle width direction and extends toward the vehicle front side in the plan view seen from the vehicle upper side. The main body projection formed at the main body light guide and emission portion extends along the main body angled wall from the vehicle width direction inner end portion of the main body light guide and emission portion.

Consequently, when viewing the vehicle from behind the vehicle, light emission from the main body projection extending along the main body angled wall can be seen in a separation portion (a gap) between the back door lamp and the main body lamp. Hence, during illumination, the back door light guide and emission portion of the back door lamp and the main body light guide and emission portion of the main body lamp are seen as being continuous with one another when viewed from behind the vehicle.

A light fitting structure according to a second aspect is the light fitting structure of the first aspect and further includes: a back door angled wall formed at a vehicle width direction outer end portion of the back door outer lens of the back door lamp, the back door angled wall being angled inwardly in the vehicle width direction and extending toward the vehicle front side in the plan view seen from the vehicle upper side; and a back door projection formed at the back door light guide and emission portion, the back door projection extending along the back door angled wall from the vehicle width direction outer end portion of the back door light guide and emission portion.

In the light fitting structure according to the second aspect, if the vehicle rear view is seen from greatly toward the vehicle width direction outer side (if the vehicle rear view is seen at a large angle with respect to the vehicle front-and-rear direction rear side and the vehicle width direction outer side), light emission from the back door projection that extends along the back door angled wall can be seen. Therefore, even when the vehicle rear view is viewed from greatly to the vehicle width direction outer side, the back door light guide and emission portion of the back door lamp and the main body light guide and emission portion of the main body lamp are seen as being continuous.

A light fitting structure according to a third aspect is the light fitting structure of the second aspect, wherein a projection length of the main body projection is longer than a projection length of the back door projection.

In the light fitting structure according to the third aspect, the projection length of the main body projection of the main body lamp is longer than the projection length of the back door projection of the back door lamp. Accordingly, light emission from the main body projection can be seen as far as the vehicle front-and-rear direction front side (deeper side) of the separation portion (the gap). Hence, the back door light guide and emission portion of the back door lamp and the main body light guide and emission portion of the main body lamp are seen as being more continuous.

A light fitting structure according to a fourth aspect is the light fitting structure of any one of the first to third aspects, wherein: the main body light source is disposed outwardly of a vehicle width direction outer end portion of the main body light guide and emission portion of the main body lamp; and the back door light source is disposed inwardly of a vehicle width direction inner end portion of the back door light guide and emission portion of the back door lamp.

In the light fitting structure according to the fourth aspect, light emitted from the main body light source enters the main body light guide and emission portion of the main body lamp through the vehicle width direction outer end portion of the main body light guide and emission portion and is guided toward the vehicle width direction inner end portion of the main body light guide and emission portion. Similarly, light emitted from the back door light source enters the back door light guide and emission portion of the back door lamp through the vehicle width direction inner end portion of the back door light guide and emission portion and is guided toward the vehicle width direction outer end portion of the back door light guide and emission portion.

Hence, the vehicle width direction outer end portion of the back door light guide and emission portion of the back door lamp and the vehicle width direction inner end portion of the main body light guide and emission portion of the main body lamp emit light each toward the side at which the other is disposed. Therefore, the back door light guide and emission portion of the back door lamp and the main body light guide and emission portion of the main body lamp are seen as being even more continuous.

According to the light fitting structure according to the first aspect, when the back door lamp and the vehicle main body lamp are illuminated, the main body light guide and emission portion and the back door light guide and emission portion that are light emission regions of the two lamps are seen as being continuous when the vehicle is viewed from behind.

According to the light fitting structure according to the second aspect, even when the vehicle is viewed from behind and from greatly to the vehicle width direction outer side, the main body light guide and emission portion and the back door light guide and emission portion that are the light emission regions are seen as being continuous.

According to the light fitting structure according to the third aspect, the main body light guide and emission portion and the back door light guide and emission portion that are the light emission regions are seen as being even more continuous in the vehicle rear view.

According to the light fitting structure according to the fourth aspect, the main body light guide and emission portion and the back door light guide and emission portion that are the light emission regions are seen as being even more continuous in the vehicle rear view.

### BRIEF DESCRIPTION OF THE DRAWINGS

Exemplary embodiments will be described in detail based on the following figures, wherein:

FIG. 1 is a rear view of a vehicle equipped with a light fitting unit in accordance with an exemplary embodiment;

FIG. 2 is a rear view schematically showing internal structures of the light fitting unit of FIG. 1;

FIG. 3 is a sectional diagram schematically showing a horizontal section cut along line 3-3 in FIG. 2;

FIG. 4 is a rear view schematically showing a state in which a main body tail lamp and a back door tail lamp of the light fitting unit of FIG. 1 are illuminated; and

FIG. 5 is a sectional diagram schematically showing a horizontal section, corresponding to FIG. 3, of a light fitting unit for a vehicle in accordance with a variant example.

### DETAILED DESCRIPTION

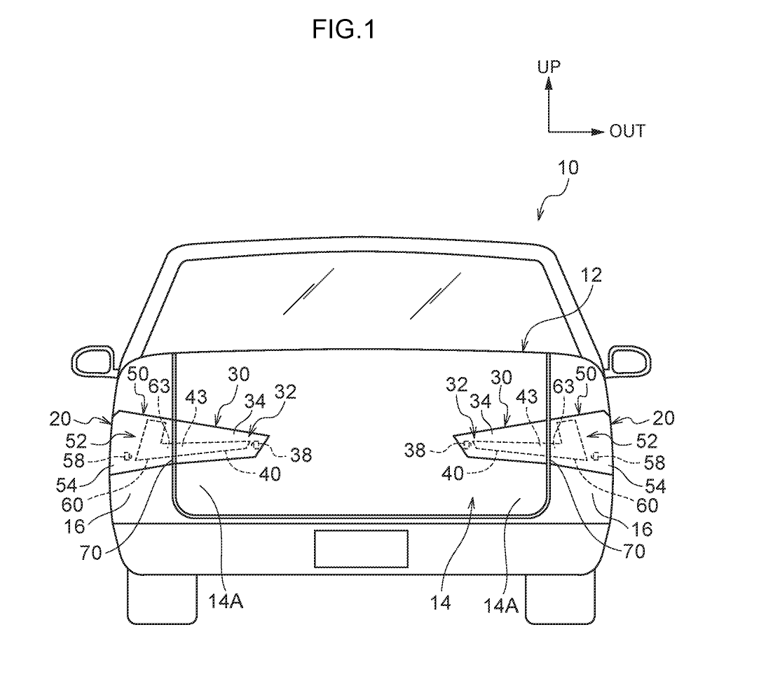

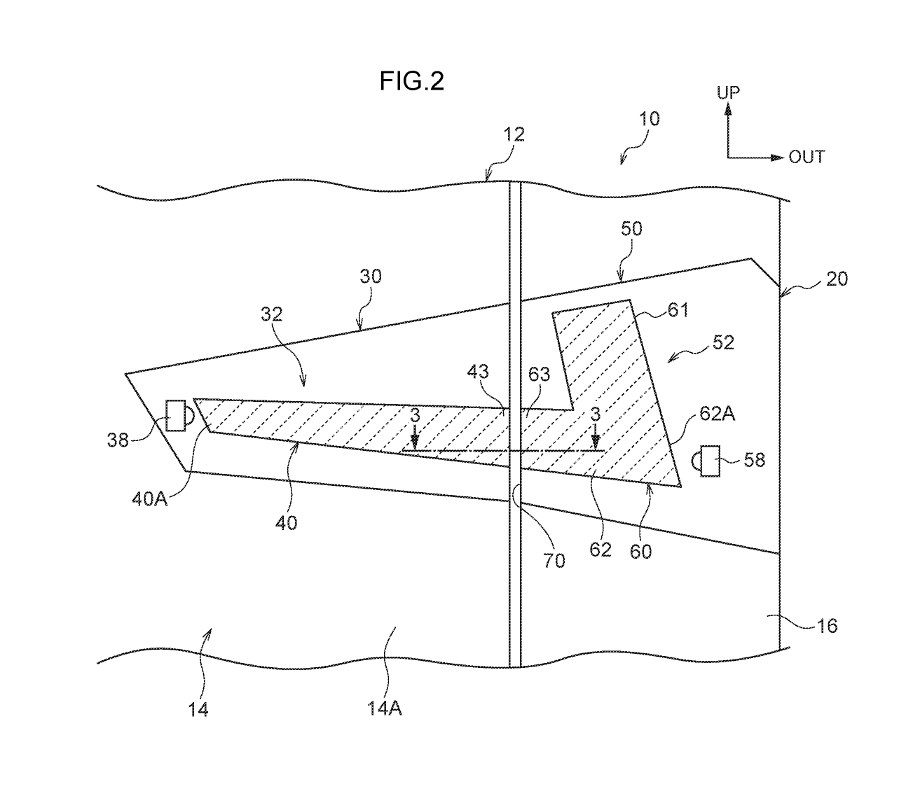

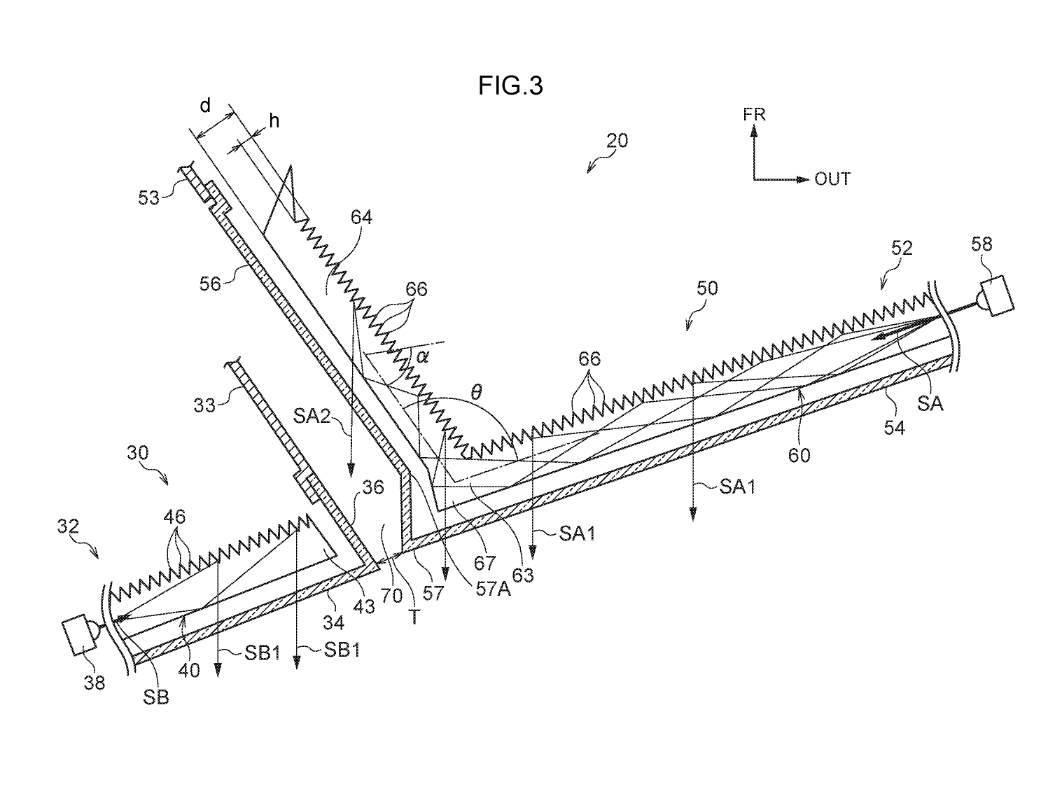

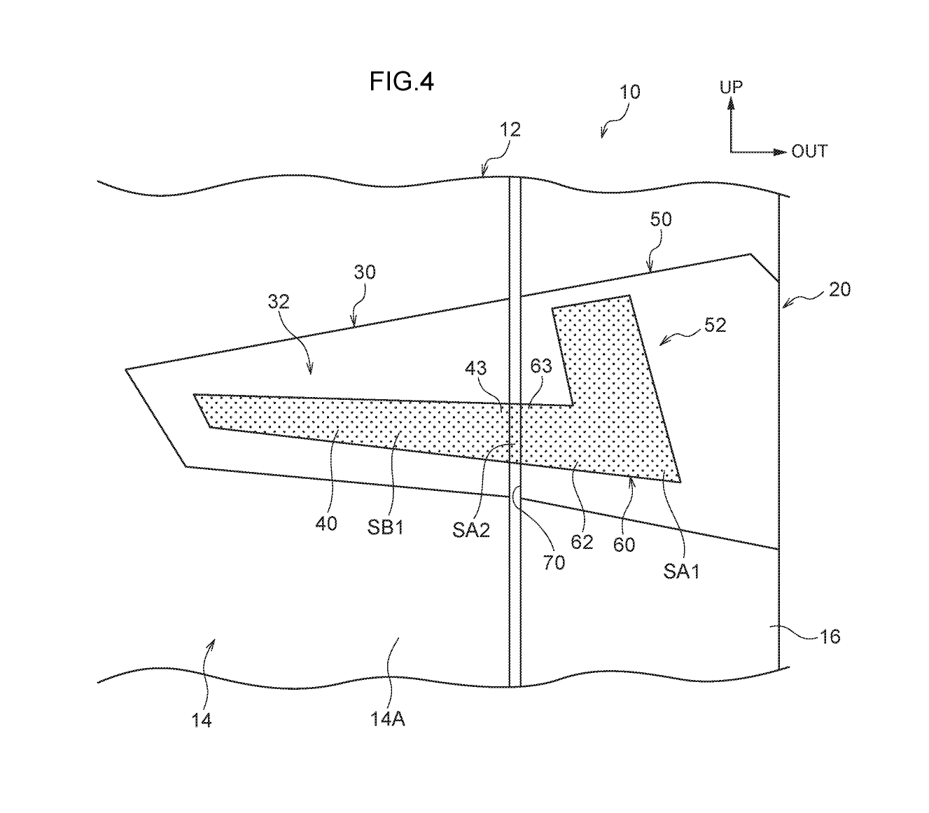

A light fitting unit 20 for a vehicle 10, in which a light fitting structure according to an exemplary embodiment is employed, is described using FIG. 1, FIG. 2, FIG. 3 and FIG. 4. The arrow UP in the drawings indicates the vehicle up-and-down direction upper side, the arrow FR indicates the vehicle front-and-rear direction front side, and the arrow OUT indicates a vehicle width direction outer side.

—Structure—

First, structures of the light fitting unit 20 in which the light fitting structure for a vehicle according to an exemplary embodiment is employed are described.

As shown in FIG. 1, the light fitting unit 20 is provided with a back door lamp 30 and a main body lamp 50. The back door lamp 30 is provided at each of side portions 14A at both sides in the vehicle width direction (left and right) of a back door 14. The back door 14 is a back door of a lifting type that opens and closes a luggage compartment (vehicle trunk), which is not shown in the drawings, in a vehicle rear end portion 12 of a vehicle 10. The vehicle back door also can be a rear hatch of a vehicle. The main body lamp 50 is provided at each of side portions 16 at both sides in the vehicle width direction (left and right) of the vehicle rear end portion 12 of the vehicle 10. Each main body lamp 50 is provided adjacent to the corresponding back door lamp 30 at the vehicle width direction outer side of the back door lamp 30. A separation portion (gap) 70 is formed between the main body lamp 50 and the back door lamp 30 (see FIG. 2 and FIG. 3).

The main body lamp 50 is a combination lamp incorporating a main body tail lamp 52 with a side light, a brake light, an indicator light and the like, which are not shown in the drawings. The back door lamp 30 incorporates a back door tail lamp 32 and the like. The main body tail lamp 52 and the back door tail lamp 32 are described below. In the following descriptions, the light fitting unit 20 at the right side in the vehicle width direction is illustrated and described. The light fitting unit 20 at the left side in the vehicle width direction has the same structure, with left-right symmetry, as the light fitting unit 20 at the right side in the vehicle width direction.

As shown in FIG. 3, the main body lamp 50 is provided with a main body outer lens 54 (see FIG. 1) that covers an opening portion of a housing 53 having an open rear face in the vehicle front-and-rear direction. The main body outer lens 54 structures (defines) a vehicle front-and-rear direction rear face of the main body lamp 50. A main body angled wall 56 is formed at a vehicle width direction inner side end portion of the main body outer lens 54. The main body angled wall 56 is angled toward the vehicle width direction inner side as the wall 56 extends toward the vehicle front-and-rear direction front side in a plan view seen from the vehicle up-and-down direction upper side.

Similarly, the back door lamp 30 is provided with a back door outer lens 34 (see FIG. 1) that covers an opening portion of a housing 33 having an open rear face in the vehicle front-and-rear direction. The back door outer lens 34 structures (defines) a vehicle front-and-rear direction rear face of the back door lamp 30. A back door angled wall 36 is formed at a vehicle width direction outer side end portion of the back door outer lens 34. The back door angled wall 36 is angled toward the vehicle width direction inner side as the wall 36 extends toward the vehicle front-and-rear direction front side in the plan view seen from the vehicle up-and-down direction upper side.

The main body angled wall 56 of the main body outer lens 54 and the back door angled wall 36 of the back door outer lens 34 are formed to be substantially parallel to each other. The main body angled wall 56 is longer than the back door angled wall 36.

In the present exemplary embodiment, a triangular portion 57 is formed at the vehicle width direction inner side end portion of the main body outer lens 54. The triangular portion 57 protrudes toward the back door outer lens 34 in the plan view seen from the vehicle up-and-down direction upper side. The main body angled wall 56 described above extends from an end portion 57A of the triangular portion 57.

As shown in FIG. 2 and FIG. 3, the main body tail lamp 52 described above is provided in the main body lamp 50. The main body tail lamp 52 includes a main body light guide and emission portion (a main body inner lens) 60 and a main body light source 58. The main body light guide and emission portion 60 is constituted by a transparent body of a transparent resin, glass or the like.

As shown in FIG. 3, the main body light guide and emission portion 60 is disposed close to the main body outer lens 54. As shown in FIG. 2, the main body light guide and emission portion 60 is formed in a substantially “L” shape in the vehicle rear view, and includes a vertical portion 61, which extends in the vehicle up-and-down direction, and a horizontal portion 62, which extends toward the vehicle width direction inner side from a lower end portion of the vertical portion 61. The main body light source 58 is provided at the outer side of a vehicle width direction outer side end portion 62A of the horizontal portion 62 of the main body light guide and emission portion 60.

As shown in FIG. 3, a main body projection portion 64 projects along the main body angled wall 56 of the main body outer lens 54 from a vehicle width direction inner side end portion 63 of the horizontal portion 62 of the main body light guide and emission portion 60. In the present exemplary embodiment, a triangular portion 67 is formed at the vehicle width direction inner side end portion 63 of the main body light guide and emission portion 60. The triangular portion 67 protrudes toward the back door outer lens 34 in the plan view seen from the vehicle up-and-down direction upper side.

As shown in FIG. 2 and FIG. 3, the back door tail lamp 32 is provided in the back door lamp 30. The back door tail lamp 32 includes a back door light guide and emission portion (a back door inner lens) 40 and a back door light source 38. The back door light guide and emission portion 40 is constituted by a transparent body of a transparent resin, glass or the like.

As shown in FIG. 3, the back door light guide and emission portion 40 is disposed close to the back door outer lens 34. As shown in FIG. 2, the back door light guide and emission portion 40 extends in the vehicle width direction. The back door light source 38 is provided at the inner side of a vehicle width direction inner side end portion 40A of the back door light guide and emission portion 40.

As shown in FIG. 2 and FIG. 3, the vehicle width direction inner side end portion 63 of the main body light guide and emission portion 60 structuring the main body tail lamp 52 of the main body lamp 50 and a vehicle width direction outer side end portion 43 of the back door light guide and emission portion 40 structuring the back door tail lamp 32 of the back door lamp 30 are disposed to oppose one another, sandwiching the separation portion (gap) 70. In the vehicle rear view (when viewing the vehicle from behind the vehicle), the horizontal portion 62 of the main body light guide and emission portion 60 and the back door light guide and emission portion 40 are arranged in a straight line.

As shown in FIG. 3, plural triangular prism portions 66 are formed at inner side regions of the main body light guide and emission portion 60. Accordingly, light SA that is emitted from the main body light source 58 and enters the main body light guide and emission portion 60 through the vehicle width direction outer side end portion 62A of the main body light guide and emission portion 60 (see FIG. 2) is reflected by the plural prism portions 66 and emitted to the vehicle front-and-rear direction rear side, as illustrated by arrows SA1 and arrows SA2. For convenience of description, light emission from the main body light guide and emission portion 60 is represented by the arrows SA1 and light emission from the main body projection portion 64 is represented by the arrows SA2 to distinguish between the two.

Similarly, plural triangular prism portions 46 are formed at inner side regions of the back door light guide and emission portion 40. Accordingly, light SB that is emitted from the back door light source 38 and enters the back door light guide and emission portion 40 through the vehicle width direction inner side end portion 40A of the back door light guide and emission portion 40 (see FIG. 2) is reflected by the plural prism portions 46 and emitted to the vehicle front-and-rear direction rear side, as illustrated by arrows SB1.

In the present exemplary embodiment, the main body light source 58 and the back door light source 38 are each constituted by light emitting diodes (LEDs) that emit red light.

—Operation and Effects—

Now, operation and effects of the present exemplary embodiment are described.

At the main body lamp 50, the light (red light) SA emitted from the main body light source 58 enters the main body light guide and emission portion 60 through the vehicle width direction outer side end portion 62A of the main body light guide and emission portion 60 and is guided by the main body light guide and emission portion 60. The light SA is reflected by the plural prism portions 66 and emitted to the vehicle front-and-rear direction rear side.

Similarly, at the back door lamp 30, the light (red light) SB emitted from the back door light source 38 enters the back door light guide and emission portion 40 through the vehicle width direction inner side end portion 40A of the back door light guide and emission portion 40 and is guided by the back door light guide and emission portion 40. The light SB is reflected by the plural prism portions 46 and emitted to the vehicle front-and-rear direction rear side.

The main body angled wall 56 that is angled toward the vehicle width direction inner side as the wall 56 extends toward the vehicle front-and-rear direction front side in the plan view seen from the vehicle up-and-down direction upper side is formed at the vehicle width direction inner side end portion of the main body outer lens 54 of the main body lamp 50, and the main body projection portion 64 that projects along the main body angled wall 56 is formed at the main body light guide and emission portion 60. Consequently, the light SA that is emitted from the main body light source 58 and enters the main body light guide and emission portion 60 through the vehicle width direction outer side end portion 62A of the main body light guide and emission portion 60 is guided to the main body projection portion 64. Then, the light SA that is guided to the main body projection portion 64 is reflected by the plural prism portions 66 and is emitted to the vehicle front-and-rear direction rear side (see the arrows SA2).

Therefore, as shown in FIG. 4, light emission from the main body projection portion 64 projecting along the main body angled wall 56 (the arrows SA2) can be seen through the separation portion (gap) 70 between the main body lamp 50 and the back door lamp 30 in the vehicle rear view (when the vehicle is viewed from behind the vehicle) (see FIG. 1 to FIG. 3). As a result, the main body light guide and emission portion 60 of the main body lamp 50 (the main body tail lamp 52) and the back door light guide and emission portion 40 of the back door lamp 30 (the back door tail lamp 32) are seen as being continuous in the vehicle rear view. Furthermore, the main body light guide and emission portion 60 and the back door light guide and emission portion 40 can be seen as being continuous even when the vehicle rear view is viewed from any direction diagonally to the right side, diagonally to the left side, diagonally to the upper side or diagonally to the lower side.

Thus, when the lamps are illuminated, the main body tail lamp 52 of the main body lamp 50 and the back door tail lamp 32 of the back door lamp 30 are seen to be continuous and integral. Therefore, visual design of the main body lamp 50 and the back door lamp 30 and visibility of the vehicle rear view are improved. Describing this from another perspective, a single design may be constituted by the main body tail lamp 52 and the back door tail lamp 32.

In the main body lamp 50, the light SA emitted from the main body light source 58 enters the main body light guide and emission portion 60 through the vehicle width direction outer side end portion 62A of the main body light guide and emission portion 60 and is guided toward the vehicle width direction inner side end portion 63 by the main body light guide and emission portion 60. Similarly, in the back door lamp 30, the light SB emitted from the back door light source 38 enters the back door light guide and emission portion 40 through the vehicle width direction inner side end portion 40A of the back door light guide and emission portion 40 and is guided toward the vehicle width direction outer side end portion 43 by the back door light guide and emission portion 40.

As a result, the vehicle width direction inner side end portion 63 of the main body light guide and emission portion 60 of the main body lamp 50 and the vehicle width direction outer side end portion 43 of the back door light guide and emission portion 40 of the back door lamp 30 emit light each toward the side at which the other is disposed. Therefore, the main body light guide and emission portion 60 of the main body lamp 50 (the main body tail lamp 52) and the back door light guide and emission portion 40 of the back door lamp 30 (the back door tail lamp 32) are seen as being even more continuous.

In the present exemplary embodiment, as shown in FIG. 3, the triangular portion 57 is formed at the vehicle width direction inner side end portion of the main body outer lens 54 and protrudes toward the back door outer lens 34 in the plan view seen from the vehicle up-and-down direction upper side. Therefore, a gap T between the main body lamp 50 and the back door lamp 30 at a vehicle front-and-rear direction rear side end portion of the separation portion 70 is narrowed. Thus, external appearance quality when the lamps are not illuminated is improved.

If a light amount of light emission from the main body projection portion 64 of the main body light guide and emission portion 60 of the main body lamp 50 (the arrows SA2) is insufficient (if the light is not bright enough), the main body light guide and emission portion 60 of the main body lamp 50 (the main body tail lamp 52) and the back door light guide and emission portion 40 of the back door lamp 30 (the back door tail lamp 32) may not be seen as being continuous.

On the other hand, if the light emission from the main body projection portion 64 of the main body light guide and emission portion 60 of the main body lamp 50 (the arrows SA2) is an excessive light amount (if the light is too bright), light leakage may occur, which may cause a boundary region (the separation portion 70) between the main body light guide and emission portion 60 of the main body lamp 50 (the main body tail lamp 52) and the back door light guide and emission portion 40 of the back door lamp 30 (the back door tail lamp 32) to be dimly lit, and the main body light guide and emission portion 60 and the back door light guide and emission portion 40 may not be seen as being continuous. Alternatively, the main body light guide and emission portion 60 and back door light guide and emission portion 40 may be seen as being continuous but the visual design of the main body lamp 50 and the back door lamp 30 may not be much improved.

Therefore, a light amount of the light emission from the main body projection portion 64 of the main body light guide and emission portion 60 of the main body lamp 50 (the arrows SA2) must be an appropriate light amount. In the present exemplary embodiment, the light amount from the main body projection portion 64 of the main body light guide and emission portion 60 may be adjusted in accordance with various specifications of the main body projection portion 64 of the main body light guide and emission portion 60. Hence, occurrences of light leakage may be easily prevented or suppressed.

These various specifications of the main body projection portion 64 of the main body light guide and emission portion 60 include a thickness d of the main body projection portion 64, an angle a of the prism portions 66 of the main body light guide and emission portion 60, a step height h of the prism portions 66, an angle 0 between the main body projection portion 64 and the horizontal portion 62 of the main body light guide and emission portion 60, all of which are shown in FIG. 3, and so forth.

—Variant Example—

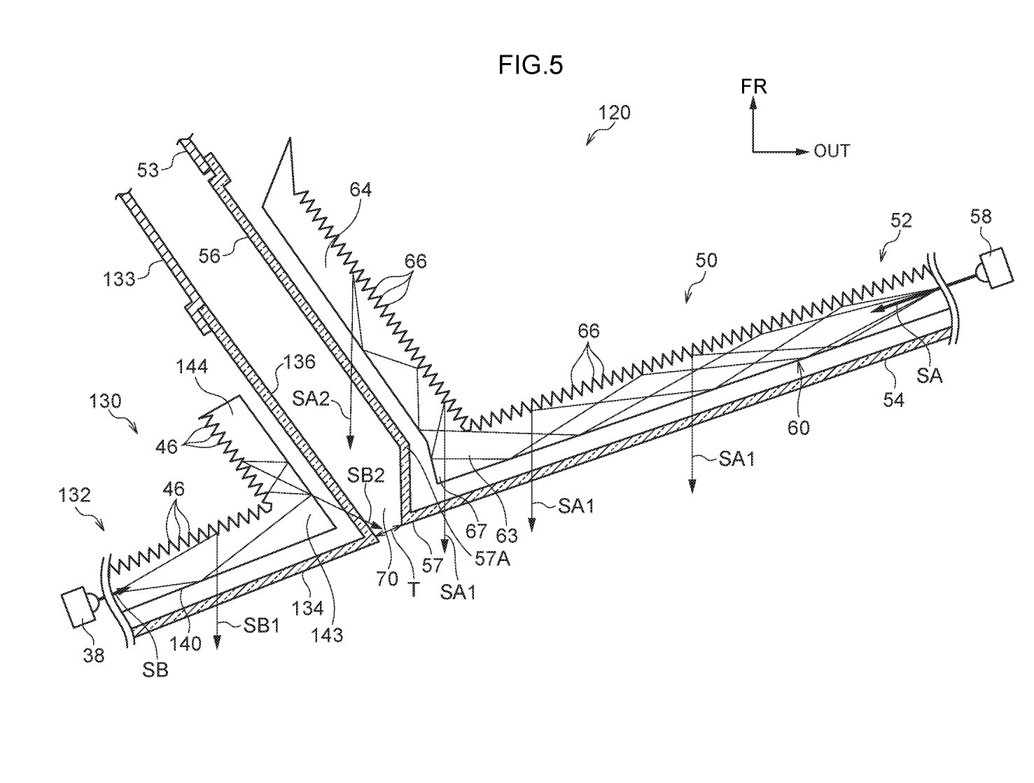

Now, a light fitting unit 120 in accordance with a variant example of the present exemplary embodiment is described using FIG. 5. In the following descriptions, members that are the same as in the exemplary embodiment described above are assigned the same reference symbols and descriptions thereof are omitted as appropriate.

—Structure—

Structures of the light fitting unit 120 according to the variant example are described. The main body lamp 50 has the same structure as in the above exemplary embodiment, so is not described again.

As shown in FIG. 5, a back door lamp 130 of the light fitting unit 120 according to the variant example is provided with a back door outer lens 134 that covers an opening portion of a housing 133 having an open rear face in the vehicle front-and-rear direction. The back door outer lens 134 structures (defines) a vehicle front-and-rear direction rear face of the back door lamp 130. A back door angled wall 136 is formed at a vehicle width direction outer side end portion of the back door outer lens 134. The back door angled wall 136 is angled toward the vehicle width direction inner side as the wall 136 extends toward the vehicle front-and-rear direction front side in the plan view seen from the vehicle up-and-down direction upper side.

The main body angled wall 56 of the main body outer lens 54 and the back door angled wall 136 of the back door outer lens 134 are formed to be substantially parallel to each other. The main body angled wall 56 is longer than the back door angled wall 136.

A back door tail lamp 132 is provided in the back door lamp 130. The back door tail lamp 132 includes a back door light guide and emission portion (a back door inner lens) 140 and the back door light source 38. The back door light guide and emission portion 140 is constituted by a transparent body of a transparent resin, glass or the like.

The back door light guide and emission portion 140 is disposed close to the back door outer lens 134. The back door light guide and emission portion 140 extends in the vehicle width direction. A back door projection portion 144 projects along the back door angled wall 136 from a vehicle width direction outer side end portion 143 of the back door light guide and emission portion 140.

The main body projection portion 64 and the back door projection portion 144 are formed to be substantially parallel to each other. A projection length of the main body projection portion 64 is longer than a projection length of the back door projection portion 144.

The plural triangular prism portions 46 are formed at inner side regions of the back door light guide and emission portion 140. Accordingly, light SB (red light) that is emitted from the back door light source 38 and enters the back door light guide and emission portion 140 through a vehicle width direction inner side end portion of the back door light guide and emission portion 140 is reflected by the plural prism portions 46 and emitted to the vehicle front-and-rear direction rear side and toward the vehicle front-and-rear direction rear side and the vehicle width direction outer side, as illustrated by arrow SB1 and arrow SB2.

—Operation and Effects—

Now, operation and effects of the present variant example are described.

The back door angled wall 136 that is angled toward the vehicle width direction inner side and extends toward the vehicle front-and-rear direction front side in the plan view seen from the vehicle up-and-down direction upper side is formed at the vehicle width direction outer side end portion of the back door outer lens 134 of the back door lamp 130, and the back door projection portion 144 that projects along the back door angled wall 136 is formed at the back door light guide and emission portion 140. Accordingly, the light SB that is emitted from the back door light source 38 and enters the back door light guide and emission portion 140 through the vehicle width direction inner side end portion of the back door light guide and emission portion 140 is guided to the back door projection portion 144 by the back door light guide and emission portion 140. The light SB is reflected by the plural prism portions 46 and emitted to the vehicle front-and-rear direction rear side and the vehicle width direction outer side (see arrow SB2).

Therefore, if the vehicle rear view is seen from the vehicle front-and-rear direction rear side (that is, if the vehicle is viewed from behind the vehicle) and the vehicle width direction outer side at a large angle (if the vehicle rear view is seen from an angle with respect to the vehicle front-and-rear direction that is larger than an angle of inclination of the main body angled wall 56), light emission from the back door projection portion 144 that projects along the back door angled wall 136 (the arrow SB2) can be seen through the separation portion (gap) 70 between the main body lamp 50 and the back door lamp 130. Therefore, even if the vehicle rear view is seen from the vehicle front-and-rear direction rear side and the vehicle width direction outer side at a large angle, the main body light guide and emission portion 60 of the main body lamp 50 (the main body tail lamp 52) and the back door light guide and emission portion 140 of the back door lamp 130 (the back door tail lamp 132) are seen as being continuous.

Similarly to the exemplary embodiment described above, occurrences of light leakage may be prevented or suppressed by adjusting a light amount at the back door projection portion 144 of the back door light guide and emission portion 140 in accordance with various specifications of the back door projection portion 144.

The main body projection portion 64 and the back door projection portion 144 are formed to be substantially parallel, and the projection length of the main body projection portion 64 is longer than the projection length of the back door projection portion 144.

Therefore, in the vehicle rear view, light emission from the main body projection portion 64 can be seen as far as the vehicle front-and-rear direction front side (deeper side) of the separation portion (gap) 70. Hence, the main body light guide and emission portion 60 of the main body lamp 50 (the main body tail lamp 52) and the back door light guide and emission portion 140 of the back door lamp 130 (the back door tail lamp 132) are seen as being even more continuous in the vehicle rear view.

—Alternative Modes—

The present disclosure is not limited by the exemplary embodiment described above.

For example, in the exemplary embodiment described above, the main body light source 58 is disposed at the outer side of the vehicle width direction outer side end portion 62A of the main body light guide and emission portion 60 and the back door light source 38 is disposed at the inner side of the vehicle width direction inner side end portion 40A of the back door light guide and emission portion 40, but this is not limiting. For example, the main body light source 58 may be disposed at the vehicle up-and-down direction upper side of the vertical portion 61 of the main body light guide and emission portion 60.

It will be clear that numerous modes may be embodied within a scope not departing from the spirit of the present disclosure.

What is claimed is:

1. A light fitting structure for a vehicle, the light fitting structure comprising:
a back door lamp provided at a vehicle width direction outer end portion of a back door provided at a rear end of a vehicle, a rear face of the back door lamp having a back door outer lens;
a main body lamp provided at the rear end of the vehicle adjacent to a vehicle width direction outer end of the back door lamp, a rear face of the main body lamp having a main body outer lens;
a back door light guide and emission portion provided in the back door lamp, the back door light guide and emission portion guiding and emitting light emitted from a back door light source;
a main body light guide and emission portion provided in the main body lamp, a vehicle width direction inner end portion of the main body light guide and emission portion disposed so as to oppose a vehicle width direction outer end portion of the back door light guide and emission portion, the main body light guide and emission portion guiding and emitting light emitted from a main body light source;
a main body angled wall formed at a vehicle width direction inner end portion of the main body outer lens of the main body lamp, the main body angled wall being angled inwardly in the vehicle width direction and extending toward the vehicle front side in a plan view seen from a vehicle upper side; and
a main body projection formed at the main body light guide and emission portion, the main body projection extending along the main body angled wall from the vehicle width direction inner end portion of the main body light guide and emission portion.

2. The light fitting structure according to claim 1, wherein the main body projection extends along the main body angled wall toward the vehicle front side and inwardly in the vehicle width direction from the inner end portion of the main body light guide and emission portion.

3. The light fitting structure according to claim 1, further comprising:
a back door angled wall formed at a vehicle width direction outer end portion of the back door outer lens of the back door lamp, the back door angled wall being angled inwardly in the vehicle width direction and extending toward the vehicle front side in the plan view seen from the vehicle upper side; and
a back door projection formed at the back door light guide and emission portion, the back door projection extending along the back door angled wall from the vehicle width direction outer end portion of the back door light guide and emission portion.

4. The light fitting structure according to claim 3, wherein the back door projection extends along the back door angled wall toward the vehicle front side and inwardly in the vehicle width direction from the outer end portion of the back door light guide and emission portion.

5. The light fitting structure according to claim 3, wherein a projection length of the main body projection is longer than a projection length of the back door projection.

6. The light fitting structure according to claim 1, wherein:
the main body light source is disposed outwardly of a vehicle width direction outer end portion of the main body light guide and emission portion of the main body lamp; and
the back door light source is disposed inwardly of a vehicle width direction inner end portion of the back door light guide and emission portion of the back door lamp.

7. The light fitting structure according to claim 1, wherein:
a triangular portion is formed at the vehicle width direction inner end portion of the main body outer lens, the triangular portion protruding toward the back door outer lens in the plan view seen from the vehicle upper side; and
the main body angled wall extends toward the vehicle front side and inwardly in the vehicle width direction from a front end portion of the triangular portion.

8. A light fitting structure for a vehicle having a front-to-back length that extends in a longitudinal direction, a left-to-right width that extends in a lateral direction, and an up-and-down height that extends in a vertical direction, the light fitting structure comprising:
a back door lamp provided at a laterally outer end of a back door provided at a longitudinally rear end of a vehicle, a rear face of the back door lamp having a back door outer lens;
a main body lamp provided at the longitudinally rear end of the vehicle adjacent to a laterally outer end of the back door lamp, a rear face of the main body lamp having a main body outer lens;
a back door light guide and emitter provided in the back door lamp, the back door light guide and emitter guiding and emitting light emitted from a back door light source;
a main body light guide and emitter provided in the main body lamp, a laterally inner end portion of the main body light guide and emitter disposed so as to oppose a laterally outer end portion of the back door light guide and emitter, the main body light guide and emitter guiding and emitting light emitted from a main body light source;
a main body angled wall located at a laterally inner end portion of the main body outer lens of the main body lamp, the main body angled wall extending toward a longitudinally forward end of the vehicle and extending laterally inwardly when viewed in a plan view from above the vehicle; and
a main body projection located at the main body light guide and emitter, the main body projection extending along the main body angled wall from the laterally inner end portion of the main body light guide and emitter.

9. The light fitting structure according to claim 8, wherein the main body projection extends along the main body angled wall toward the longitudinally forward end of the vehicle and laterally inwardly from the laterally inner end portion of the main body light guide and emitter.

10. The light fitting structure according to claim 8, further comprising:
a back door angled wall located at a laterally outer end portion of the back door outer lens of the back door lamp, the back door angled wall extending toward a longitudinally forward end of the vehicle and extending laterally inwardly when viewed in a plan view from above the vehicle; and
a back door projection formed at the back door light guide and emitter, the back door projection extending along the back door angled wall from the laterally outer end portion of the back door light guide and emitter.

11. The light fitting structure according to claim 10, wherein the back door projection extends along the back door angled wall toward the longitudinally forward end of the vehicle and laterally inwardly from the laterally outer end portion of the back door light guide and emitter.

12. The light fitting structure according to claim 10, wherein a projection length of the main body projection is longer than a projection length of the back door projection.

13. The light fitting structure according to claim 8, wherein:
the main body light source is disposed laterally outwardly of a laterally outer end portion of the main body light guide and emitter; and
the back door light source is disposed laterally inwardly of a laterally inner end portion of the back door light guide and emitter.

14. The light fitting structure according to claim 8, wherein:
a triangular portion is formed at the laterally inner end portion of the main body outer lens, the triangular portion protruding toward the back door outer lens in the plan view from above the vehicle; and
the main body angled wall extends toward the longitudinally forward end of the vehicle and laterally inwardly from a longitudinally forward end portion of the triangular portion.
